(19) United States
(12) Patent Application Publication
(10) Pub. No.: US 2017/0132937 A1
(43) Pub. Date: May 11, 2017

(54) SETTING METHOD IN NO-FLY ZONE FOR UNMANNED AERIAL VEHICLES

(71) Applicant: SHENZHEN WISDOW FORMING SCIENCE AND TECHNOLOGY DO., LTD., ong. Shenzhen (CN)

(72) Inventors: QiuYan ZENG, Shenzhen (CN); TangSheng LEI, Shenzhen (CN)

(73) Assignee: Shenzhen Wisdow Forming Science and Technology do. LTD.

(21) Appl. No.: 14/907,574

(22) PCT Filed: Jan. 20, 2016
(86) PCT No.: PCT/CN2016/071489

§ 371 Date: Jan. 26, 2016

(30) Foreign Application Priority Data
Nov. 5, 2015 (CN) 201510747292.X

(51) Int. Cl. G08G 5/00

(52) U.S. Cl. CPC G08G 5/006; G08G 5/0069

(57) ABSTRACT

A setting method in a no-fly zone for unmanned aerial vehicles comprises collecting a request of the no-fly zone of the user, and checking the request of the no-fly zone of the users. lithe checking passes, an outline of the no-fly zone is set and a map data is updated.

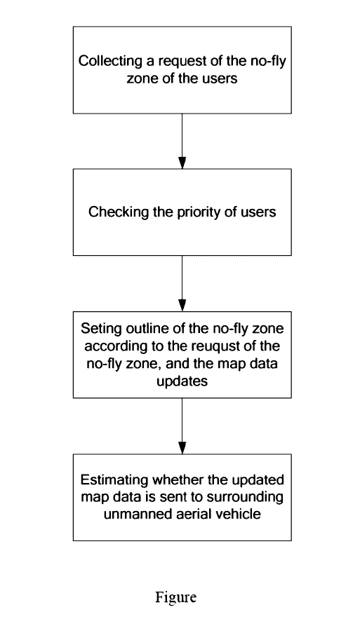

### TECHNICAL FIELD

The present disclosure relates to unmanned aerial vehicles, and more particularly to a setting method in a no-fly zone for the unmanned aerial vehicles.

### BACKGROUND

An unmanned aerial vehicle has a wide range of application in both professional and civil fields. As prices of the unmanned aerial vehicles decreases, the unmanned aerial vehicle will expand to more fields to use.

However, more problems will continue. The unmanned aerial vehicles are in flight without limits, which harasses both private spaces and public spaces that are unfit for flight. In media use, the unmanned aerial vehicle is used to collect information first time when an emergency happens, which affects work of emergency departments. For example, when a rescue helicopter is needed in the emergency, the unmanned aerial vehicle can seriously affect safety of the rescue helicopter, further delaying rescue time. Therefore, the above problem is needed to be solved.

### SUMMARY

The aim of the present disclosure is to provide a setting method in a no-fly zone for unmanned aerial vehicles capable of reminding information of the no-fly zone for the unmanned aerial vehicles or users.

The aim of the present disclosure is achieved by the following methods: the setting method in the no-fly zone for the unmanned aerial vehicles comprises:

collecting a request of the no-fly zone of the users;

checking the request of the no-fly zone of the users, if the checking passes, an outline of the no-fly zone is set and map data is updated.

The present disclosure makes the request of the no-fly zone of the users set and update in the map data, which reminds the no-fly zone for the users by map and avoids fighting in the no-fly zone, further protecting the privacy of the nominal users or avoiding affecting work of the emergency.

### BRIEF DESCRIPTION OF FIGURES

The FIGURE is a flowchart of a setting method in a no-fly zone for unmanned aerial vehicles of the present disclosure.

### DETAILED DESCRIPTION

The present disclosure will be described in detail in accordance with the figures and the examples.

### Example 1

As shown in the FIGURE, a setting method in a no-fly zone for unmanned aerial vehicles of the example are used to make request of the no-fly zone from public or organizations transmit to users of the unmanned aerial vehicles or other people. To be specific, the setting method is used to send information of the no-fly zone to a locator device of the unmanned aerial vehicles or a hand-held terminal of the users of the unmanned aerial vehicle when an emergency happens. The setting method in the no-fly zone for the unmanned aerial vehicles comprises:

collecting a request of the no-fly zone of the users, the request of the no-fly zone of the users at least comprises a basic identifying information of the users and a location information of the users;

checking the request of the no-fly zone of the users, if the checking passes, the location information of the users updates in a map data, and sends the location information to other users or provides the location information for other user to download.

To be specific, collecting a request the no-fly zone of the users and the location information of the no-fly zone can be a requirement accepted by a map service providers or other map server. And checking the request of the no-fly zone of the users is achieved by a set automatic checking procedure. It should be understood that a manual checking procedure takes over the automatic checking procedure.

Furthermore, priority of the users is checked, the request of the no-fly zone of the users should comprise characteristics of the users, such as department information or identity information of the users. According the characteristics of the users, if the users belong to department of the emergency or high priority, the priority of the users is greater than a preset value, the location information of the users updates in a map data, and sends the location information to other Users, which makes the unmanned aerial vehicles evacuate the no-fly zone, or avoids flighting in the no-fly zone without knowing.

The information of the no-fly zone is updated to the map data and is sent to surrounding unmanned aerial vehicles in the no-fly zone. Sending the information of the no-fly zone to the unmanned aerial vehicle has two situations: one: the information of the no-fly zone is sent to a locator device of the unmanned aerial vehicles, and the locator device of the unmanned aerial vehicles estimate whether location of the unmanned aerial vehicles is in the no-fly zone, if the unmanned aerial vehicles are in the no-fly zone, alarm is automatically sent to the user or operator: two: the information of the no-fly zone is directly sent to the hand-held terminal of the operator of the unmanned aerial vehicles, such as a dedicated hand-held terminals or phones. A sending range comprises a no-fly zone and a preset range expanded by the no-fly zone, for example, if a radius of the no-fly zone is two hundred meters, the preset range can be three hundred meters.

In the example, in the updated map data, the priority of the no-fly zone is marked, which makes other unmanned aerial vehicle estimate the priority of the current no-fly zone, further estimating if the unmanned aerial vehicles evacuate as soon as possible.

As the request of the no-fly zone in emergency, only a location information of a central point of circular area is provided and the required radius of circular area is regarded as the no-fly zone according to a location information of the no-fly zone. The radius information of the no-fly zone is provided for request of the no-fly zone and is sent to the users.

As the request of the no-fly zone in emergency, a time interval of the no-fly zone is set according to the request of the users and the map data is simultaneously updated to send the users. The time interval of the no-fly zone in the update map data is marked. It should consider that the request of the no-fly zone is relieved according to the request of the users and sent relieved request of the no-fly is sent.

In the example, height of the no-fly zone is set according to the priority of the users when the request of the no-fly zone of the users is checked, and the height of the no-fly zone is updated to the map data and is remarked in the map.

### Example 2

The setting method in the no-fly zone for the unmanned aerial vehicles of the example is used to make request of the no-fly zone from public or organizations transmit to users of the unmanned aerial vehicle or other people. To be specific, the example uses reminding information of the no-fly zone method for a locator device of the unmanned aerial vehicle or a hand-held terminal of the users of the unmanned aerial vehicles, which avoids affecting normal life and privacy of normal people. The reminding method comprises:

collecting a request of the no-fly zone of the users, the request of the no-fly zone of the users at least comprises characteristics of the users and a location information of the users:

checking priority of users, if the priority of the users is less than a preset value, the users are the normal users;

obtaining outline of the no-fly zone in the location information; a preset outline is equal with or is greater than the outline of the no-fly zone, to be specific, the outline of the no-fly zone can expand some meters along outside, which makes private space not violate.

The example is according to the request of the normal users, such as residence, private place, where they have anomaly outline. Therefore, it is difficult to provide accurate outline of the no-fly zone for the normal users. The normal users only provide outline information of the user-defined requirement zone. The outline information is preliminary delimited in as terminal screen and is sent to the map server, and is checked by the map server or people. Finally, the outline of the no-fly zone is determined according to matching the outline of the residence or private place in the map.

Perhaps, the normal users only provide a current locating information and checking information, such as residence address, identity information. The server locates corresponding checking residence or private place according to the locating information to confirm relevant information, therefore, the outline of the no-fly zone is directly set according to the outline of the residence or private place.

Perhaps, the normal users only provide a current address, such as “XXXX” address is output. The map data in the server has whole outline of the “XXXX” address, automatic identifies and sets the outline of the no-fly zone.

Request of the no-fly zone is up to the requirement, such as whether the no-fly zone is belong to the private place, or the outline exceed range of the private place. If the request of the no-fly zone is up to the requirement, the outline of the no-fly zone is updated to the map data and the updated map data is sent to the users of the map data. It should be understood that data interface is provided for the unmanned aerial vehicle to download. Download way of the unmanned aerial vehicle of the example comprises: the locator device of the unmanned aerial vehicle automatically download or the users of the unmanned aerial vehicle download by the terminal.

When the outline e information of the no-fly zone is checked, the outline information of the no-fly zone is compared with setting range of the map data to obtain a result. If the result is in the setting range, the checking passes. If the result is not in the setting range, the request of the no-fly zone is rejected.

The height of the no-fly zone is set according to the priority of the users when the request of the no-fly zone of the users is checked, the height of the no-fly zone is updated to the map data and is remarked in the map, which makes the unmanned aerial vehicle flight free and protect the privacy of the normal users. It should be understood that the height of the no-fly zone is checked, if the height of the no-fly zone is in tolerance range, the checking passes.

The present disclosure is described in detail in accordance with the above contents with the specific preferred examples. However, this present disclosure is not limited to the specific examples. For the ordinary technical personnel of the technical field of the invention, on the premise of keeping the conception of the present disclosure, the technical personnel can also make simple deductions or replacements, and all of which should be considered to belong to the protection scope of the present disclosure.

1. A setting method in a no-fly zone for unmanned aerial vehicles, comprising;
collecting a request of the no-fly zone of users of the unmanned aerial vehicles; and checking the request of the no-fly Zone of the Users; if the checking passes, an outline of the no-fly zone is set and a map data is updated.

2. The setting method in the no-fly zone for the unmanned aerial vehicles of claim 1, Wherein the updated map data is sent to the users.

3. The setting method in the no-fly zone for the unmanned aerial vehicles of claim 1, wherein characteristics of the users are obtained: priority of the users is checked according to the characteristics of the users; if the priority of the users is greater than a preset value, the set outline of the no-fly zone updates in the map data and is sent to other users of the map.

4. The setting method in the no-fly zone for the unmanned aerial vehicles of claim 3, wherein the priority of the users is remarked in the updated map data.

5. The setting method in the no-fly zone for the unmanned aerial vehicles of claim 3, wherein location information of the no-fly zone is updated to the map data and is sent to surrounding unmanned aerial vehicles.

6. The image processing method for the unmanned aerial vehicles of claim 1, wherein a required radius of circular area is regarded as the no-fly zone according to location information of the no-fly zone, is updated to the map data and is sent to map users.

7. The setting method in the no-fly zone for the unmanned aerial vehicles of claim 1, wherein an outline of the no-fly zone is obtained according to a location information of the no-fly zone; a preset outline is equal to or is greater than the outline of the no-fly zone.

8. The setting method in the no-fly zone for the unmanned aerial vehicles of claim 1, wherein a time interval of the no-fly zone is set according to the request of the users and the map data is simultaneously updated to send to the user.

9. The setting method in the no-fly zone for the unmanned aerial vehicles of claim 3, wherein a location information of the no-fly zone comprises an outline of the no-fly zone; when the outline information of the no-fly zone is checked, outline information of the no-fly zone is compared with a setting range of the map data to obtain a result to check.

10. The setting method in the no-fly zone for the unmanned aerial vehicles of claim 1, wherein height of the no-fly zone is set according to priority of the users.
